(19) United States
(12) Patent Application Publication
(10) Pub. No.: US 2015/0310984 A1
(43) Pub. Date: Oct. 29, 2015

(54) ENCLOSED MULTIPLE-GAP CORE INDUCTOR

(71) Applicant: MAGicALL, Inc., Camarillo, CA (US)

(72) Inventors: Dinyu Qin, Oak Park, CA (US); Joel Bradley Wacknov, Westlake Village, CA (US)

(21) Appl. No.: 14/697,164

(22) Filed: Apr. 27, 2015

Related U.S. Application Data
(60) Provisional application No. 61/984,088, filed on Apr. 25, 2014.

(51) Int. Cl. H01F 27/28; H01F 27/02; H01F 27/24; H01F 1/153

(52) U.S. Cl. CPC H01F 27/2823; H01F 1/15333; H01F 27/02; H01F 27/24

(57) ABSTRACT

In some embodiments, an inductor may include a core formed from a plurality of segments and having a plurality of discrete gaps and a winding encircling the plurality of segments so as to substantially enclose the core.

### CROSS-REFERENCE TO RELATED APPLICATIONS

This application claims priority to U.S. Provisional Patent Application No. 61/984,088, filed Apr. 25, 2014, entitled Enclosed Multiple-Gap Core Inductor, the content of which is hereby incorporated by reference herein in its entirety.

### FIELD OF THE INVENTION

The present disclosure relates to inductors. In particular, the disclosure relates to inductors with fully or substantially enclosed cores. Still more particularly, the disclosure relates to inductors with fully or substantially enclosed cores, where the core includes discrete gaps and the surrounding winding is an edge wound coil.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An inductor may be made of a core and a winding which is wound around the core. An inductor core may be made of a loop of magnetic material. To achieve a particular inductance range, the core may be made to have a particular range of magnetic permeability. Since most magnetic core materials' original permeability values are too high, approaches may be taken to reduce an inductor core's effective permeability. One way to reduce a core's effective permeability is to introduce a gap or multiple gaps into the core. Gaps may be discrete or distributed, for example. Discrete gaps in a core may be left as open air gaps or may be filled or partially filled with non-magnetic materials. Distributed gaps may be formed between particles through the use of, for example, a powder material when forming the core. Other processes such as crystallization may also be used to form distributed gaps within a core.

One or more coils of wire may be wound around the core to form a winding; the core and winding together forming an inductor. The winding may enclose the core to some degree. For example, an enclosed core may be entirely or substantially covered by the winding. A non-enclosed core may have substantial portions of the core that are not covered by the winding. In particular, two distinct inductor versions are often available. The first version is an inductor with a laminated core and a discrete gap that is not fully enclosed and leaves a fair amount of the core exposed. The second version is an inductor with a toroidal powder core having distributed gaps and a winding that more fully encloses the core.

The coil wires used for foaming windings are often round in cross section. Coil wires with a rectangular cross section may also be used. These rectangular cross sections may be relatively easily wound against the long side of the cross section. However, this approach to winding may not efficiently utilize the volume around the core and, as such, may not result in a very powerful and/or efficient inductor relative to comparable inductors with a similar size and shape.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to an inductor having a magnetic core formed from a plurality of segments and having a plurality of discrete gaps, each gap being arranged between a pair of adjacent segments, and having one or more coils encircling the plurality of segments so as to substantially enclose the core. In some embodiments, the inductor may have a ratio of total winding length to a mean magnetic length of at least approximately 0.70, 0.75, or 0.85. The plurality of segments may be comprised of laminations. The winding may include an edge-wound coil in some embodiments. It may be a rectangular edge-wound coil. The coil may be pre-wound on a bobbin according to some embodiments.

The present disclosure, in another embodiment, relates to an inductor having a core with a substantially rectangular cross section with a center. The core may include a circular shape with a circular axis arranged at the center of the cross section. The core may include a plurality of segments of laminated construction and a plurality of radially extended gaps each arranged between pairs of the plurality of segments. The inductor may also include one or more coils wrapped around the rectangular cross section of the core to form a toroid winding having an axis substantially aligned with the circular axis of the core. The winding may substantially enclose the core. The inductor may have a ratio of total winding length to a mean magnetic length of at least approximately 0.75 or 0.85. The winding may be an edge-wound winding in some embodiments. It may be a rectangular edge-wound winding. According to some embodiments, the core segments may comprise laminated materials having one of or a combination of an amorphous material, nanocrystalline material and silicon steel.

The present disclosure, in yet another embodiment, relates to a grid tie inverter or a battery charger with an inductor having an inductor core formed from a plurality of segments and having a plurality of discrete gaps arranged between a pair of adjacent segments. The inductor may also include an inductor winding encircling the plurality of segments so as to substantially enclose the core. In some embodiments, the inductor winding may be formed from an edge wound coil. In some embodiments, the inductor core may be a laminated core.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1A is a diagram of a gapped inductor core.

FIG. 1B is a side view thereof.

FIG. 2 is a photo of a non-enclosed inductor with a gapped core.

FIG. 3 is a photo of an enclosed inductor.

FIG. 4 is a view of an inductor core with a winding, according to some embodiments.

FIG. 5A is a plan view of the inductor core of FIG. 4, according to some embodiments.

FIG. 5B is a side view of the inductor core of FIG. 4, according to some embodiments.

FIG. 6 is a plan view of the winding of FIG. 4 without a core and depicting the winding length.

FIG. 7 is a view of an inductor without a winding and depicting the mean magnetic length.

FIG. 8 is a view of an inductor core with a winding and depicting the winding length.

### DETAILED DESCRIPTION

The present application, in some embodiments, relates to an inductor with an enclosed core having a plurality of discrete gaps. That is, typical enclosed core inductors have toroidal powder cores with distributed gaps, not discrete gaps, and inductors with discrete gaps are constructed without being fully enclosed. In the presently described embodiments, the plurality of discrete gaps may reduce inductor power loss over cores with only one or two discrete gaps. In addition, multiple discrete gaps may be advantageous over distributed gaps because a wider range of core and inductor sizes can be created using multiple discrete gaps than can be created using such materials as toroidal powder to create distributed gaps. In some embodiments, the present application relates to an inductor with an enclosed core wrapped in an edge-wound winding. An edge-wound winding may allow for more efficient use of the inductor space.

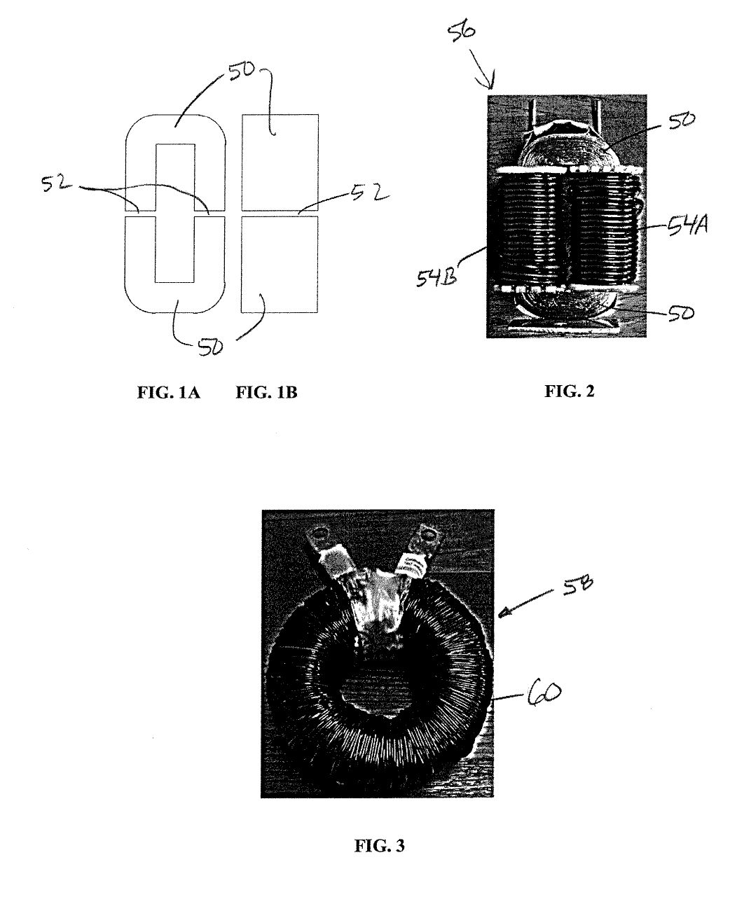

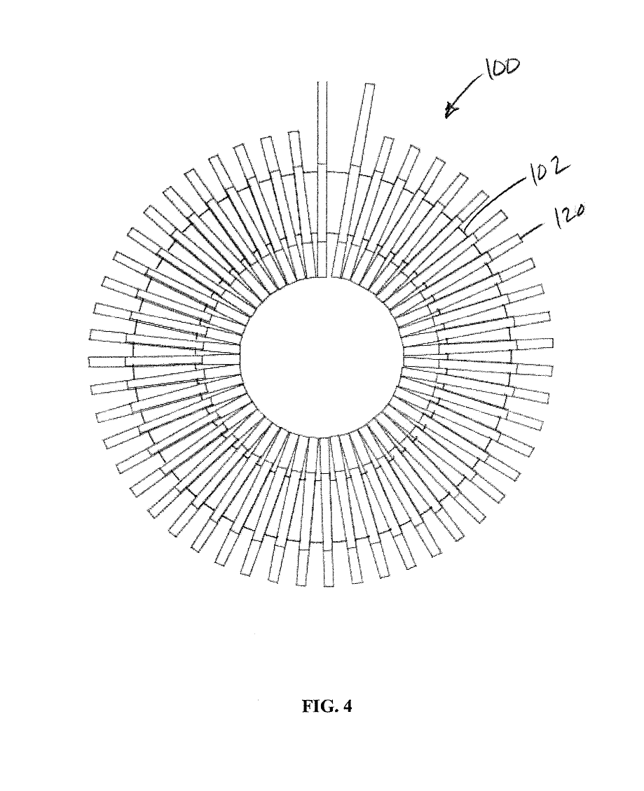

FIGS. 1-3 present some examples of inductor core and winding configurations that help to explain the details of non-enclosed, substantially enclosed, and fully enclosed inductors in addition to the differences between distributed gap cores in comparison to cores with discrete gaps. FIGS. 1A and 1B show an example of a core 50 with two discrete gaps 52. FIG. 2 illustrates an inductor constructed with the core 50 of FIG. 1 and winding 54. Typically, a core 50 with discrete gaps 52 is left non-enclosed by the winding 54, as shown in FIG. 2. That is, a substantial portion of the core 50 is left exposed and not wrapped by the winding 54. As may be appreciated from FIG. 2, each of the coils 54A/B may be created and a horseshoe-shaped core 50 may be inserted from each end into the pair of coils 54A/B to form the inductor 56 (i.e., the coils 54A/B together forming winding 54). As such, the non-enclosed nature of the inductor 56 may contribute to its ease of construction. In contrast to FIGS. 1 and 2, FIG. 3 illustrates an example of an enclosed core inductor 58. The core for the inductor shown in FIG. 3 does not include discrete gaps and, instead, has distributed gaps or is a toroidal powder core. That is, the core of the inductor in FIG. 3 is a solid donut shape that results from its powder core construction. In contrast to the inductor 56 of FIGS. 1 and 2, the construction of such an inductor 58 involves threading a wire or group of wires 60 through the center of the donut shape and repeatedly winding the wire 60 around and through the donut making a way around the donut and back to where the process was started. The winding of the wire 60 allows for using the core as a form to shape the wire as it is wrapped around the core.

Turning now to FIG. 4, an inductor 100 according to some embodiments of the present disclosure is shown. As shown, an inductor 100 may be provided having a core 102 and a winding 120. The inductor 100 may be configured for electrical connection to a circuit and/or grid at a plurality of locations such as, for example, at each end of the winding 120. The inductor 100 may have a generally circular shape where the winding 120 is wound around a generally circular core 102. Other shapes of inductors may also be provided such as, oval shapes, rectangular shapes, square shapes, triangular shapes and the like.

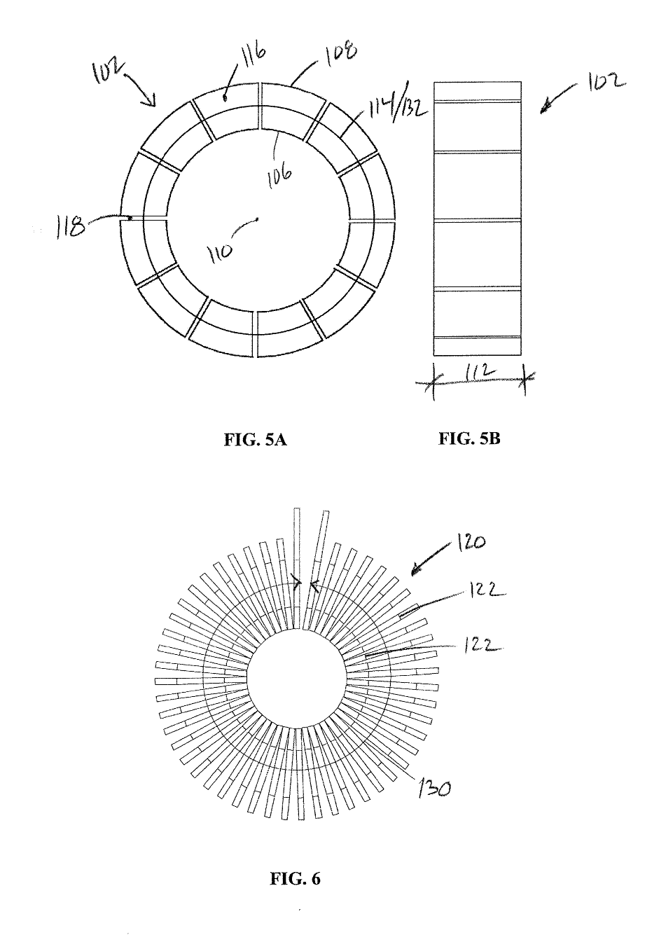

As shown in more detail in FIGS. 5A and 5B a core 102 may be provided. The core may be generally circular or, more particularly, annular in shape when viewed in the plan view of FIG. 5A, for example. The generally annular shape may have an inside radius edge 106 and an outside radius edge 108 where the inside and outside are defined based on their relative distance to the center 110 of the annular shape, the inside edge 106 being closer to the center 110. The annular shape shown may be considered a closed shape that starts and ends at a same or similar location. As shown in FIG. 5B, the core may have a thickness 112 measured generally perpendicularly to the annular shape. The core 102 may be generally rectangular or square in cross-section and may have a center defining a circular axis 114 of the core 102 extending along the length of the core 102. Other cross-sectional shapes such as round, annular, triangular, or other cross-sectional shapes may be used. While a particularly shaped core 102 is shown, still other core shapes may be provided. For example, the geometry shown in FIG. 5A may be such that the inside and outside edges 106, 108 define a generally rectangular or square shape, or a triangular, oval, or other shape may be provided. In some embodiments, the core shape might not be a closed shape and, instead, a straight, u-shaped, arc-shaped, or otherwise open-shaped core 102 may be provided.

The core 102 may be made up of multiple core segments 116 separated by discrete gaps 118. As shown, for example, the core 102 may include 12 core segments 116 arranged in series around the annular shape defined by the inside and outside edges 106, 108. Each core segment 116 may include a truncated wedge shape having a radiused inside edge and a radiused outside edge where the plurality of radiused inside and outside edges contribute to define the inside and outside edges 106, 108 of the core. In other embodiments, the core segments 116 may have straight edges on the inside and/or outside rather than radiused edges. That is, the core segments 116 may be substantially trapezoidal when viewed from a view similar to that of FIG. 5A. In still other embodiments the core segments 116 may be substantially square or rectangular when viewed from a view similar to that of FIG. 5A. While 12 core segments are shown, other numbers of segments such as 2, 3, 4, 5, or other integer values up to and beyond 12 may also be provided. The core segments 116 may be of generally equal size separated by discrete gaps 118 or core segments 116 that vary in size may be used. It is to be appreciated that the number of segments or gaps may increase in value particularly above 1 or 2 gaps. That is, particular advantage may be appreciated with 3, 4, 5, or more gaps. In some embodiments, 5, 6, 7, 8, 9, 10, 11, or 12 gaps may be provided. Still other numbers of gaps above the numbers mentioned may be provided.

The core 102 may be composed in part or in whole of iron or any other magnetic or ferromagnetic material according to some embodiments. In some embodiments, the segments 116 may be made of laminations, such as silicon steel, amorphous, nanocrystalline, or other suitable magnetic material. In some embodiments, a core 102 may be formed by winding a strip of material into a ring and then cutting the ring into sections to create a core 102 similar to that of FIG. 5A. In other embodiments, the core segments 116 may be made by stacking pre-cut laminations. In still other embodiments, core segments 116 may be formed by laying strip material repeatedly to create a stack of strip material. The stack of strip material may be laid on its side and cut across the width of the stacked material with alternating skewed cuts to create segments 116 that resemble the segments of FIG. 5A, but have straight inside and outside edges (i.e., trapezoidal shapes). That is, the segments 116 cut from the lengthwise strip with skewed cuts may be alternately flipped to align all of the short edges such that the several segments curve and create a generally annular shape like that of FIG. 5A, but with straight inside and outside edges on each segment. In other cases where generally rectangular or square segments are used, such a lengthwise strip of material may simply be crosscut generally perpendicular to the strip. In other embodiments, rather than strip material, the core segments may be made with magnetic powder material, such as ferrite, iron powder, or other powder materials.

As shown, the core 102 may have a plurality of discrete gaps 118. Depending on the nature and shape of the core segments 116, the gaps 118 may have a particular shape. For example, as shown in FIG. 5A, the gaps may be substantially equal in width as the gaps 118 pass across the core 102 and extend radially outward from the inside edge 106 toward the outside edge 108. In other embodiments, the gap width may vary as they pass across the core 102 from the inside edge 106 to the outside edge 108.

In some embodiments, the gaps 118 may be air gaps or gaps that are generally unfilled, but occupied by the atmospheric conditions around the inductor. In other embodiments, the gaps 118 may be filled or partially filled with glue, tape, non-magnetic materials or other material for securing one section 116 to another and maintaining the gap spacing between the sections 116 of the core. In other embodiments, other gap filling systems may be provided such as particular gases or materials. In still other embodiments, spacers, brackets, or other systems may be provided for securing the core segments 116 relative to one another.

Turning now to FIG. 6, a winding 120 of the inductor 100 is shown. The winding 120, when the inductor 100 is considered in cross-section, may repeatedly extend around the circumference of the cross-sectional boundary of the core 102 in the form of a coil as it continually circumscribes the cross-section of the core 102 and extends along the length of the core 102. In some embodiments, the winding 120 may be coiled relatively densely such that adjacent portions of the winding are in contact with one another and in other embodiments, the winding 120 may be coiled less densely. In some embodiments, the winding 120 may be coiled relatively tightly such that wire of the winding 120 is in close proximity to the surface of the core and in other embodiments, the winding 120 may be coiled relatively loosely allowing for space between the surface of the core 102 and the inside surface of the winding 120. The winding 120 may have a center when the inductor is viewed in cross-section and the center of the winding may align with the center of the cross-section of the core 102 such that an axis of the winding 120 is generally in line with an axis of the core 102.

Various wire types may be used to create a winding 120 according to different embodiments. A wire may include an insulated or uninsulated copper wire, or wires of other conducting materials, either insulated or uninsulated. A wire may have generally any cross-sectional shape, such as a circle, square, rectangular shape, annular shape, or another cross-sectional shape. Various methods and manners of winding the wire into a coil may also be employed.

In some embodiments, and as shown in FIGS. 4 and 6, the winding 120 may be made from a substantially rectangular wire such as a rectangular, square, or modified rectangular shape such as those with chamfered or rounded corners and approaching oblong or oval shapes. Such substantially rectangular wires may be edge-wound into a coil and used as an inductor winding. An edge-wound coil may be bent against the short side of the rectangular cross-section (i.e, about the strong axis). In some embodiments, an edge-wound coil may be continuously curved into a coil such that the coil has a round perimeter or otherwise smooth perimeter when the inductor is viewed in cross-section. In other embodiments, an edge-wound coil may be formed with intermittent bend lines 122 to form a square, rectangular, hexagonal, octagonal, or other shape with a number of sides when the inductor 100 is viewed in cross-section. As shown in FIGS. 4 and 6, the bend lines 122 in the coil are shown as each ring in the coil extends around the core 102.

Bending such a rectangular wire may require much more strength and control than bending the wire against its long side (i.e. about the weak axis). Current enclosed inductors with toroidal powder cores do not implement edge-wound coils because of this difficulty. That is, due to the single piece continuity of a toroidal powder core, the coil may be formed into a coil shape at the same time as is it positioned around the core and, as such, wire cross-sections that are easy to manage and bend may be used such that the wire can be coiled and wrapped around the core simultaneously. In many cases, these coils may be hand wound such that edge-winding is not even contemplated because it would be too difficult to perform by hand.

In contrast to toroidal powder cores, the above-described segmented core 102 with discrete gaps 118 may allow the coil for the winding 120 to be formed on a machine outside the presence of the core 102. That is, the control and strength of a machine may be utilized to create the edge-wound winding 120 and issues of interference or accommodation of the core 102 during the winding process may be avoided. The nature of an edge-wound winding 120 may cause it to be flexible. That is, it may be stretchable similar to a slinky or other edge-wound device where the ability for longitudinal stretch is dependent on the weak axis of the cross-section rather than the strong axis. In light of the high relative flexibility of an edge-wound winding 120 in its coiled condition, the beginning and end of a given winding 120 may be relatively easily separable exposing the hollow space within the winding 120. Segments of the core 102 or several connected segments of the core may, thus, be placed into the hollow space from the beginning and/or end of the winding 120. This may be completed section by section (or groups of sections by groups of sections) including placement of any gap controlling elements or material. The inductor shape may be finalized and/or secured, for example, by strapping, potting, or other form holding techniques, for example.

An edge-wound winding 120 may provide benefits to the inductor function and manufacture process. The winding 120 and discrete gapped core 102 may be manufactured efficiently. This may be, in part, because the edge-winding may be completed fully and efficiently by a machine. In addition, spaces between the wires of the winding 120 may provide cooling to both the core 102 and the winding 120. That is, the edge-wound nature of the winding 120 may allow for more turns of the wire, more efficiently utilizing the space around the core 102, and, at the same time, allowing for cooling of the windings particularly on the outer perimeter where portions of the winding may have some air gap between them.

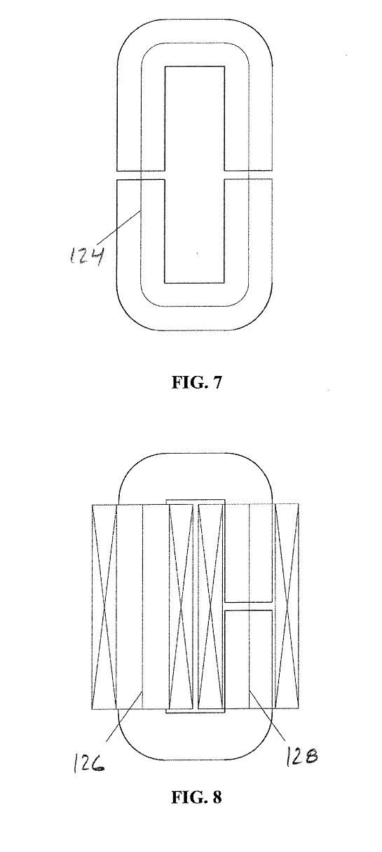

Enclosing the core 102 more fully may increase material utilization. That is, with more uniform core 102 and winding 120 shapes, the enclosed core 102 configuration uses significantly less core 102 and/or winding 120 materials. As such, a more efficient inductor may be provided. The core 102 of an inductor 100 may be considered to be “enclosed” when a large majority of the mean magnetic length of the core 102 is covered by the winding 120. For example, with reference to FIGS. 7 and 8 in some embodiments, if the ratio of the total length of winding to the length of the mean magnetic path 124 is over 65%, the core 102 may be considered to be enclosed. The length of the mean magnetic path 124 may be the mean length of the magnetic path in an inductor core 102. That is, in some embodiments, it may be measured along the centerline of the core as shown in FIG. 7. Similarly, the length of a winding 120 may be the length of the winding 120 measured along the mean magnetic path from a plane where the magnetic path first enters the winding 120 to the plane where the magnetic path exits the winding 120. In cases where wind-over occurs (i.e., where the coil winds over itself) the length along the core would not be counted more than once. In some embodiments, multiple coil lengths may be added together to determine the total length of the winding, as shown in FIG. 8. For example, if the total length (126+128) of the coil in FIG. 8 is measured to be 140 units, and the length of the mean magnetic path in FIG. 7 is measured to be 236 units, then the ratio of total length of the winding 120 to the length of the mean magnetic path 124 is 140/236=59.3%. Thus, the inductor core of FIG. 8 may not be considered to be “enclosed.” A core may have a wide range of enclosure values ranging from 0.30-1.0, 0.40-1.0, 0.45-1.0, 0.5-1.0, 0.55-1.0, 0.60-1.0, 0.65-1.0, .70-1.0, .75--1.0, 0.80-1.0, 0.85-1.0, or 0.90-1.0. However, a core may be considered to be substantially enclosed when the ratio of the total length of coils to the mean magnetic length of the core is approximately 0.70-1.0, 0.75-1.0, 0.80-1.0, 0.85-1.0, 0.90-1.0, or 0.95-1.0. (i.e., equal to or above 70%, 75%, 80%, 85%, 90%, or 95%). Any integer value or fraction there of my also be used.

Referring back now to FIGS. 4, 5A and 6, an inductor with an enclosed core 102 is shown. That is, looking to the ratio of the total length of winding to the length of the mean magnetic path, if the total length 130 of the winding 120 in FIG. 6 is measured to be 394 units, and the length 132 of the mean magnetic path in FIG. 5A is measured to be 411 units, then the ratio of total length 130 of the winding 120 to the length 132 of the mean magnetic path is 394/411=95.8%. Thus, the inductor core 102 in FIG. 4 may be considered “enclosed.”

In some embodiments, the present described inductors 100 may be constructed very cost-efficiently and may provide for a power level remarkably higher than similarly sized counterpart inductors. This may be because of the discrete gap core, which may allow for adjustment and optimization of the core permeability. In addition, this may be because of the full enclosure of the core by the winding and it may also be because of the efficient use of space by the edge-wound coil. Accordingly, a remarkably higher powered inductor may be created using the techniques described above. One or more embodiments of the present disclosure may also be advantageous by providing a reduced core and/or winding usage, thereby reducing inductor size and cost relative to other inductors. In addition, the embodiments disclosed herein may reduce power losses relative to other inductors enabling the inductors to have a higher efficiency than previously known options.

Multiple-gapped cores 102 such as that shown in FIG. 4 may be advantageous relative to single-gapped cores because they may reduce inductor power losses. For example, core fringing effect core loss, winding eddy current and proximity effect losses, and other losses may be greatly reduced by the core's multiple gaps. Thus, a core 102 with ten 0.1-inch gaps may be more efficient and exhibit less power loss than a similar core with a single 1-inch gap. This may be true in fully enclosed core inductors but this may also be true when the core is not fully enclosed. The use of multiple discrete gaps 118 may also provide advantages over the use of distributed gaps, such as those that are formed with toroidal powder cores. For example, core materials with better performance and/or lower cost than powder materials can be used. Cores 102 with multiple discrete gaps 118 may also allow for better magnetic performance at a much lower cost.

In some embodiments, the inductors disclosed herein may be used in grid-tie inverters such as inverters for solar power or wind power, for example. In other embodiments, the disclosed inductors may be used in battery chargers such as those for electric automobiles and equipment. Still other applications and uses of the disclosed inductors may be implemented.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. An inductor, comprising:
a magnetic core formed from a plurality of segments and having a plurality of discrete gaps, each gap being arranged between a pair of adjacent segments; and
a winding encircling the plurality of segments so as to substantially enclose the core.

2. The inductor of claim 1, wherein a ratio of a total winding length to a mean magnetic length is at least approximately 0.70.

3. The inductor of claim 1, wherein a ratio of a total winding length to a mean magnetic length is at least approximately 0.75.

4. The inductor of claim 1, wherein a ratio of a total winding length to a mean magnetic length is at least approximately 0.80.

5. The inductor of claim 1, wherein a ratio of a total winding length to a mean magnetic length is at least approximately 0.85.

6. The inductor of claim 1, wherein the segments comprise laminations.

7. The inductor of claim 1, wherein the winding is an edge-wound winding.

8. The inductor of claim 7, wherein the winding is a rectangular edge-wound winding.

9. The inductor of claim 1, wherein the winding is pre-wound on a bobbin.

10. An inductor, comprising:
a core having a substantially rectangular cross-section with a center, the core having a circular shape with a circular axis arranged at the center of the cross-section, the core comprising a plurality of segments of laminated construction and a plurality of radially extending gaps each arranged between pairs of the plurality of segments; and
one or more coils wrapped around the rectangular cross-section of the core to form a toroid winding having an axis substantially aligned with the circular axis of the core, wherein the winding substantially encloses the core.

11. The inductor of claim 10, wherein a ratio of a total winding length to a mean magnetic length is at least approximately 0.70.

12. The inductor of claim 10, wherein a ratio of a total winding length to a mean magnetic length is at least approximately 0.75.

13. The inductor of claim 10, wherein a ratio of a total winding length to a mean magnetic length is at least approximately 0.80.

14. The inductor of claim 10, wherein the winding is an edge-wound winding.

15. The inductor of claim 14, wherein the winding is a rectangular edge-wound winding.

16. The inductor of claim 10, wherein the core segments comprise laminated materials comprising one or a combination of an amorphous material, nanocrystalline material, and silicon steel.

17. A device, comprising:
an inductor, comprising:
an inductor core formed from a plurality of segments and having a plurality of discrete gaps arranged between a pair of adjacent segments; and
an inductor winding encircling the plurality of segments so as to substantially enclose the core.

18. The device of claim 17, wherein the inductor winding comprises an edge wound winding.

19. The device of claim 17, wherein the inductor core is a laminated core.

20. The device of claim 17, wherein the device is one of a grid tie inverter and a battery charger.
